(19) United States
(12) Patent Application Publication
(10) Pub. No.: US 2014/0075698 A1
(43) Pub. Date: Mar. 20, 2014

(54) FLEXIBLE INTERDENTAL BRUSH APPLICATOR AND INTERDENTAL GUM STIMULATOR

(71) Applicants: Wai-Kuen LUI, Hong Kong (CN); William Wai-Shing LUI, Cortlandt Manor, NY (US)

(72) Inventors: Wai-Kuen LUI, Hong Kong (CN); William Wai-Shing LUI, Cortlandt Manor, NY (US)

(21) Appl. No.: 14/088,439

(22) Filed: Nov. 24, 2013

Related U.S. Application Data
(63) Continuation-in-part of application No. 13/724,110, filed on Dec. 21, 2012.
Application No. 13/724,110 is a division of application No. 10/593,701, filed on Sep. 19, 2006, now Pat. No. 8,342,193.
(60) Provisional application No. 60/554,636, filed on Mar. 19, 2004.
(60) Provisional application No. 60/602,893, filed on Aug. 19, 2004.

(51) Int. Cl. A61C 15/00

(52) U.S. Cl. CPC A61C 15/00
USPC 15/167.2

(57) ABSTRACT

The present invention provides a dental hygiene apparatus comprising an interdental brush applicator and interdental stimulator that is flexible to allow users to clean in between their teeth effectively. Users can adjust the angle of the interdental brush applicator and stimulator into a configuration that best suits their particular needs. When flex adjusted, the applicator is able to hold its new configuration while maintaining sufficient strength to allow the user to comfortably maneuver the apparatus to properly clean in between the teeth or stimulate the gums. Furthermore, the apparatus is disposable, rendering it convenient to use after a meal when the user is away from a private bathroom setting.

### FIELD OF THE INVENTION

This invention relates generally to dental hygiene instruments. In one embodiment, the present invention provides a flexible interdental brush applicator and interdental gum stimulator.

### BACKGROUND OF THE INVENTION

Typical manipulation of the interdental brush with the hands and fingers can be uncomfortable activities that result in manual as well as oral discomfort. Because the hands and fingers are intimately involved and the activity is an invasive one involving the mouth, using interdental brush can be a messy activity that people may feel uncomfortable in undertaking outside of a private bathroom setting, such as at home. In addition, it can be difficult to clean all the gaps in between all the teeth with a stiff interdental brush, especially the gaps in between teeth situated further back in the mouth. For unskilled users, interdental brush can cause discomfort and/or injury.

The present invention provides an interdental brush attached to a flexible device that allows users to apply the interdental brush in multiple angles to clean in between all the teeth with one single device.

### SUMMARY OF THE INVENTION

In one embodiment, the present invention provides an apparatus for interdental hygiene that manipulates and applies an interdental brush for cleaning the interstices of the teeth. In particular, it is an object of this invention to provide an interdental brush applicator that is strong, but pliable, with a flexible elbow that enables sufficient maneuverability to properly clean in between the teeth, including the teeth in the rear of the mouth.

In another embodiment, there is provided an apparatus with a pliable tapered end, preferably pick-like, for cleaning the teeth and massaging and stimulating the gums.

In one embodiment, the present invention provides an economical and disposable interdental brush applicator that is convenient to carry during excursions where a user will not have ready access to a private bathroom setting. Such applicators are also suitable for dispensing by restaurants to their patrons, in the same manner as mints are freely dispensed.

In one embodiment, the present invention provides a dental hygiene apparatus, comprising: (a) an elongated handling means having a longitudinal axis; (b) a teeth-cleaning means comprising an interdental brush, wherein the interdental brush is oriented longitudinally as related to the longitudinal axis of the handling means; and (c) a flexible means between the teeth-cleaning means and the handling means, wherein the flexible means is integral with the teeth-cleaning means and the handling means in that the flexible means, the teeth-cleaning means and the handling means are of one construction, and the flexible means is pliable so that the teeth-cleaning means can be brought laterally to either side of the longitudinal axis of the handling means to have an about 90 degrees angle between the teeth-cleaning means and the longitudinal axis of the handling means.

In one embodiment, the elongated handling means comprises a tapered portion at one end. In another embodiment, the tapered portion is chisel-shaped or pointed.

In one embodiment, the teeth-cleaning means is capable of adhering to a new position after flex adjustment at the flexible means.

In one embodiment, the present invention further provides a dental hygiene apparatus, comprising: (a) an elongated handle having a longitudinal axis; (b) a cleaning head comprising an interdental brush; and (c) a flexible elbow between the cleaning head and the elongated handle, wherein the flexible elbow is integral with the cleaning head and the elongated handle in that the flexible elbow, the cleaning head and the elongated handle are of one construction, and the flexible elbow is pliable so that the cleaning head can be brought laterally to either side of the longitudinal axis of the handle to have an about 90 degrees angle between the cleaning head and the longitudinal axis of the handle.

In one embodiment, the elongated handle comprises a tapered end which is integral with the elongated handle. In another embodiment, the tapered end is chisel-shaped or pointed. In yet another embodiment, the tapered end is pliable so that it can be bent about 90 degrees to the right or to the left.

In one embodiment, the elongated handle comprises ridges, grooves, or a combination thereof.

In one embodiment, the apparatus, in whole or in part, is constructed of a thermoplastic resin.

In one embodiment, the cleaning head is capable of adhering to a new position after flex adjustment at the flexible elbow.

These and other objects and advantages of this invention will become apparent to those skilled in the art after considering the following detailed specification together with the accompanying drawings.

### BRIEF DESCRIPTION OF THE FIGURES

FIG. 1 shows one embodiment of the Flexible Interdental Brush Applicator and Interdental Gum Stimulator. Presented is a side view of the apparatus illustrating the detailing of the applicator and its utilitarian sections: the tapered end 1; the middle handle 2 for grip; the flexible elbow 3; and the interdental brush 4.

FIG. 2 illustrates a 90 degree bending of the interdental brush permitted by the flexible elbow.

FIG. 3 illustrates the 0, 45 and 90 degree bending of the interdental brush permitted by the flexible elbow.

FIG. 4 shows the top view of how the flexible interdental brush applicator is used for cleaning in between the back teeth in the left side of the mouth.

FIG. 5 shows the top view of how the flexible interdental brush applicator is used for cleaning in between the back teeth in the right side of the mouth.

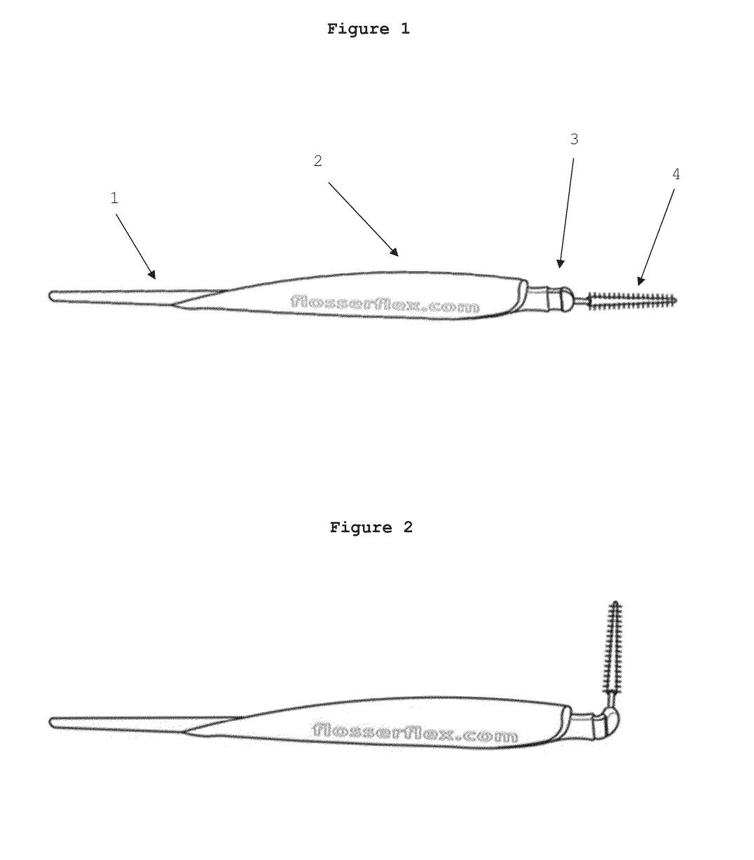

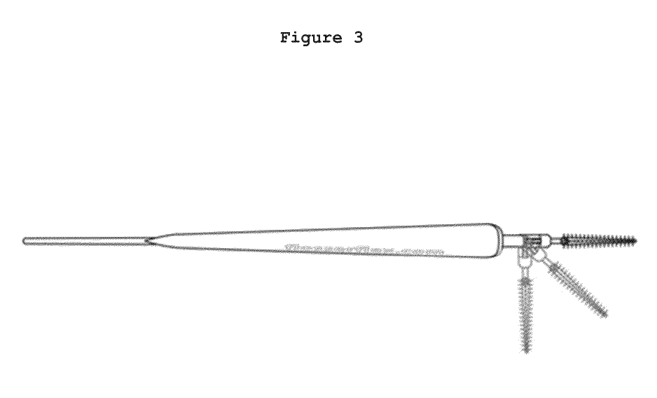

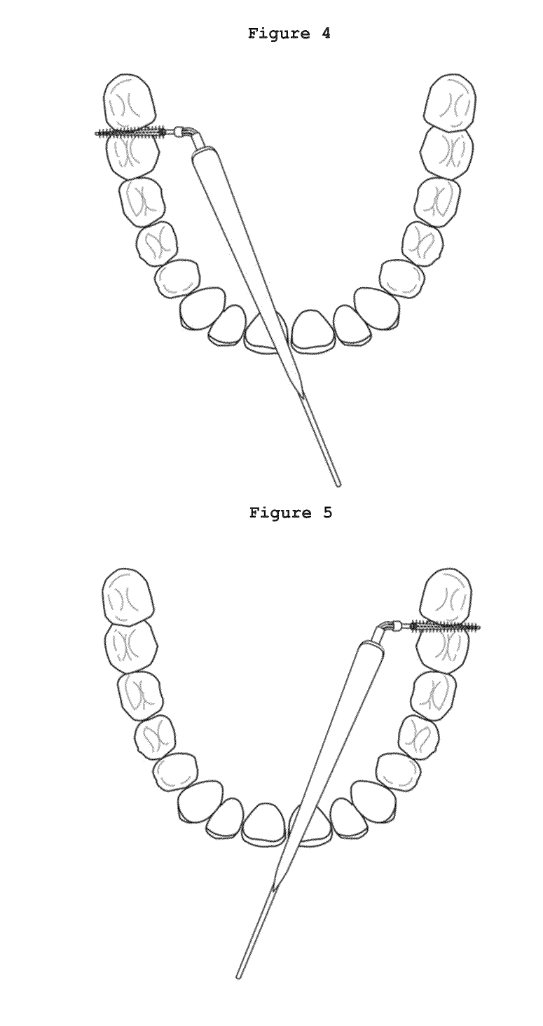

### DETAILED DESCRIPTION OF THE INVENTION

The present invention provides a dental hygiene apparatus with teeth-cleaning means and a flexible handling means whereby the teeth-cleaning means and the flexible handling means are united and pliable at their points of joinder. The teeth-cleaning means and handling means are “united” in the sense that they are brought together to form a single apparatus by joining, securing, connecting, linking, or the like. The apparatus can be of one construction or an aggregate of parts composed of the same or different material, consistent with the teachings of this disclosure.

“Pliable” means that the apparatus is flexible and receptive to change such that it is capable of being flex adjusted (bent) numerous times without breaking and will readily adhere to a new configuration after flex adjustment. The meaning will become more apparent upon reading the full disclosure and the examples contained herein.

In one embodiment, the teeth-cleaning means comprises an interdental brush. In another embodiment, the dental hygiene apparatus further comprises a tapered portion at one end of the apparatus, chisel-shaped or pointed, for use as an interdental cleaner and/or stimulator.

The dental hygiene apparatus of the present invention further provides a flexible elbow and tapered end for increased maneuverability and effectiveness when cleaning the teeth. Between the flexible elbow and tapered end is the handling means which comprises, in one embodiment, a handle with ridges, grooves, or a combination thereof for the desired grip.

In one embodiment, the dental hygiene apparatus is made of one solid construction of polypropylene. It comprises a narrow, chisel-shaped feature at one end which gradually transitions and widens into a handle and before tapering to a flexible elbow adjoining a interdental brush. The flexible elbow and chisel-shaped feature are pliable and designed to permit maximum maneuverability for the user when cleaning between teeth. Many other embodiments are possible and will become apparent upon reading the entire disclosure and the examples contained herein.

### Flexible Feature:

In one embodiment, approximately where the handle transitions into the teeth-cleaning means or the interdental brush, there is a ridged flexible elbow that is capable of being flex adjusted into the desired position when cleaning in between teeth. The user needs merely bend the apparatus at the flexible elbow to the desired angle. The dental hygiene apparatus is designed such that it is pliable but yet remains sufficiently strong for use, despite numerous flex adjustments.

For instance, the user may flex adjust the flexible elbow anywhere from 0 to about 15 degrees when cleaning in between the teeth in the front of the mouth. When cleaning in between the teeth on the side, the user may desire to flex adjust the flexible elbow anywhere from about 15 to 30 or to about 45 degrees. When cleaning in between the teeth in the rear of the mouth, the user may then desire to flex adjust the flexible elbow anywhere from about 45 to 60 or to about 90 degrees. The invention is such that the apparatus will remain at the desired angle after it is flex adjusted. When cleaning in between the teeth at the other side of the mouth, the user need merely flex adjust apparatus as described above. The apparatus can be flex adjusted multiple times and still remain strong.

In one embodiment, the interdental brush applicator is designed for single-use and thus be disposable. Inmost circumstances, one single interdental brush applicator will last for an entire cleaning in between session, depending on the number of flex adjustments. During a complete cleaning in between session, users will be bending the flexible elbows to the left and the right, and to different angles. The flexible elbow is designed to withstand multiple bendings. Some users may just want to clean one or two gaps between their teeth, so they would bend the flexible elbow maybe just 2 times. Other users may bend the flexible elbow 5 times before discarding the interdental brush applicator. During a typical cleaning in between session, users may bend the flexible elbow about 10 times. During a long cleaning in between session, users may bend it about 20 times. If the users intend to reuse the interdental brush applicator, the flexible elbow should be able to last, for example, until about 40 bendings before breaking. Experiments were conducted on the prototypes of the interdental brush applicators to see how many times a flexible elbow can be flex adjusted (bent) before it breaks. A group of 50 applicators were tested. Table 1 shows a summary of the results:

TABLE 1
Summary of Results For Bending Experiments

| Number of Times the Interdental | Percent of Interdental Brush |
|---|---|
| Brush Applicator were Bent | Applicator That Break |
| 2 | 0% |
| 5 | 0% |
| 10 | 0% |
| 20 | 0% |
| 40 | 2% |

### Flexible Pick:

In one embodiment, on one end of the interdental brush applicator is a tapered portion, chisel-shaped or pointed, that can be a used as a pick to clean the teeth and to stimulate the gums. The tapered portion is designed to be pliable such that a user can bend it to effectively reach the gums and interstices of the back teeth.

Typically, when people use toothpicks, the teeth in the front of the mouth do not present a challenge. However, there is difficulty in trying to reach the interstices of the back teeth because the toothpick is straight and cannot reach the rear interstices since they are essentially perpendicular to the toothpick. As a result, people will try to bend the toothpicks, but the results are limited. The toothpicks are not very flexible and can only be bent so much before they begin to splinter.

In contrast, the flexible tapered end (pick) of the present invention (like the flexible elbow discussed previously) can be bent anywhere from 0 to about 15, 30, 45, 60, or about 90 degrees depending on which teeth and gums the user wishes to clean and stimulate.

Like the flexible elbow, the tapered end (pick) of the apparatus is designed so as to “remember” and remain in the adjusted position while it is being used. In other words, the flexible tapered end will not bounce back to its original position after one stops applying force to it.

Like the flexible elbow, the flexible tapered end is designed to withstand multiple bending. A flexible pick can be bent a number of times during a session. Some users just want to pick one or two gaps between their teeth, so they may bend the flexible pick maybe 2 times. During a longer session, users may bend it 10, 20, or more times. The flexible pick should be able to withstand 20 flex adjustments without breaking. Experiments were conducted on the prototypes of the interdental brush applicators to see how many times the flexible pick can be bent before breaking. A group of 50 apparatus were tested. Table 2 shows a summary of the results:

TABLE 2
Summary of Results For Bending Experiments

| Number of Times the | Percent of Dental |
|---|---|
| Dental Picks were Bent | Picks That Break |
| 2 | 0% |
| 5 | 0% |
| 10 | 0% |
| 20 | 0% |

### Material:

In one embodiment, the flexible feature of the interdental brush applicator is accomplished by using a class of polypropylene materials possessing the desired properties of being able to “remember” a new position when flex adjusted and having the requisite strength necessary for manipulation of the applicator/stimulator while still being yielding enough to allow for the safe and gentle cleaning of the interdental spaces and proximate gum tissues. Suitable thermoplastic resins and polymers may be used to wholly or partly construct the apparatus so as to provide it with the desired characteristics described. In one embodiment of the present invention, polypropylene has performed particularly well. In another embodiment, colors can also be added to increase the appeal to users of all ages and groups. From the colors of the rainbow, pastels, or fluorescents, the applicators can be manufactured in an array of colors according to the target audience. For example, bright, “fun” colors may be used to attract a younger user by making the interdental brush applicator appear appealing as opposed to clinical and unpleasant. In one embodiment of the present invention, the class of polypropylene has the physical properties shown in Table 3:

TABLE 3
Physical Properties of Polypropylene

| Physical | ASTM | | |
|---|---|---|---|
| Properties | Methods | Units | Value |
| Melt flow rate | D1238L | gram/10 minutes | 15 |
| Density | D792 | Gram/cm³ | 0.904 |
| Tensile Strength, | D638 | Kg/cm2 | 365 |
| yield | | | |
| Elongation, yield | D638 | % | 9 |
| Flexural modulus | D790IA | Kg/cm² | 17000 |
| Hardness, Rockwell | D785A | R scale | 100 |
| Heat deflection | D648 | ° C. | 100 |
| temperature at 4.6 | | | |
| kg/cm² | | | |
| Izod impact | D256A | Kg-cm/cm | 2.3 |
| strength, | | | |
| Notched Mold | D995 | % | 1.51 |
| shrinkage | | | |

The invention is significant because of the following reasons: To clean in between all the teeth properly, the interdental brush should be positioned such that it is parallel to the gap between teeth. However, the gaps between the teeth in the front of the mouth are perpendicular to the gaps between the teeth in the back of the mouth. Most existing disposable interdental brush applicators have their handle parallel to the interdental brush.

While it is quite easy to clean in between the teeth in the front, it is all but impossible to clean the teeth at the back properly. The solution provided by the present invention is a disposable interdental brush applicator that allows the users to easily manipulate the angle of the interdental brush.

This invention is significant because if the interdental brush applicator is flexible, users can now adjust the applicator such that the sharp dental simulator will never point toward the vulnerable portions of the mouth, thus promoting safe use.

This invention is significant because if the interdental brush applicator is flexible, it is feasible for the manufacturer to make a longer interdental brush applicator. A longer interdental brush applicator achieves at least two goals. 1.) It is now impossible to point the sharp dental stimulator toward the mouth flesh or gums when in use because it is too long. The chance of getting hurt during cleaning in between is reduced. 2.) Users can control the applicators without putting their fingers in their mouths. Thereby, users do not need to open their mouths extra wide during cleaning in between, allowing them to clean in between teeth more discreetly if they intend to do so in public.

Users have different preferences and needs regarding how they use interdental brush. A interdental brush applicator allows users to be creative in how to achieve the task of comfortably placing the interdental brush between the teeth or maneuvering the interdental stimulator/pick within the mouth in a safe and comfortable manner.

In one embodiment, the present invention is pocket size, can be made disposable, and thus can be carried in public and used in a discreet and unembarrassing manner.

In one embodiment of the invention, the handle and applicator arm are formed from polypropylene. In another embodiment, the handle itself comprises an interdental stimulator (pick) and then widens into a thicker middle (designed for a secure grip) and then narrows down before softly angling up and transitioning into the applicator. In a further embodiment, at the point of transition a strong, flexible section capable of repeated bending is imbedded [or externally applied] providing for a 90 degree adjustable sweep of the applicator in either direction. The apparatus is such that it will respond to pressure without losing the desired angle and shape, thus allowing for easy and gentle usage. The pick is also designed to be flexible such that it can reach the back teeth and gums.

What is claimed is:

1. A dental hygiene apparatus, comprising:
(a) an elongated handling means having a longitudinal axis;
(b) a teeth-cleaning means comprising an interdental brush, wherein the interdental brush is oriented longitudinally as related to the longitudinal axis of the handling means; and
(c) a flexible means between the teeth-cleaning means and the handling means, wherein the flexible means is integral with the teeth-cleaning means and the handling means in that the flexible means, the teeth-cleaning means and the handling means are of one construction, and the flexible means is pliable so that the teeth-cleaning means can be brought laterally to either side of the longitudinal axis of the handling means to have an about 90 degrees angle between the teeth-cleaning means and the longitudinal axis of the handling means.

2. The apparatus of claim 1, wherein the elongated handling means comprises a tapered portion at one end.

3. The apparatus of claim 3, wherein the tapered portion is chisel-shaped or pointed.

4. The apparatus of claim 1, wherein the teeth-cleaning means is capable of adhering to a new position after flex adjustment at the flexible means.

5. A dental hygiene apparatus, comprising:
(a) an elongated handle having a longitudinal axis;
(b) a cleaning head comprising an interdental brush; and
(c) a flexible elbow between the cleaning head and the elongated handle, wherein the flexible elbow is integral with the cleaning head and the elongated handle in that the flexible elbow, the cleaning head and the elongated handle are of one construction, and the flexible elbow is pliable so that the cleaning head can be brought laterally to either side of the longitudinal axis of the handle to have an about 90 degrees angle between the cleaning head and the longitudinal axis of the handle.

6. The apparatus of claim 5, wherein the elongated handle comprises a tapered end which is integral with the elongated handle.

7. The apparatus of claim 6, wherein the tapered end is chisel-shaped or pointed.

8. The apparatus of claim 6, wherein the tapered end is pliable so that it can be bent about 90 degrees to the right or to the left.

9. The apparatus of claim 5, wherein the elongated handle comprises ridges, grooves, or a combination thereof.

10. The apparatus of claim 5, wherein the apparatus, in whole or in part, is constructed of a thermoplastic resin.

11. The apparatus of claim 5, wherein the cleaning head is capable of adhering to a new position after flex adjustment at the flexible elbow.
